(19) United States
(12) Patent Application Publication
(10) Pub. No.: US 2004/0136901 A1
(43) Pub. Date: Jul. 15, 2004

(54) Process for the catalytic conversion of a gasoline composition

(76) Inventors: Geert Marten Bakker, Amsterdam (NL); Roger Francis Cracknell, Chester (GB); Gert Jan Kramer, Amsterdam (NL); Christopher Morley, Chester (GB); Eric Johannes Vos, Amsterdam (NL)

Correspondence Address: Yukiko Iwata, Shell Oil Company, Legal - Intellectual Property, P. O. Box 2463, Houston, TX, 77252-2463, US

(21) Appl. No.: 10/685,029

(22) Filed: Oct. 14, 2003

(30) Foreign Application Priority Data
Oct. 14, 2002 (QZ) 02257104.6

(51) Int. Cl. C01B 3/02

(52) U.S. Cl. 423/648.1

(57) ABSTRACT

A process for the catalytic conversion of a gasoline composition into a gas mixture containing carbon monoxide and hydrogen is provided, comprising contacting a mixture of the gasoline composition and an oxygen-containing gas and/or steam with a catalyst for steam reforming, autothermal reforming or partial oxidation. The gasoline composition contains at most 40% by volume of alkylate and at most 3% by volume of olefins having 6 or more carbon atoms and has a RON of at least 85. The gas mixture comprising carbon monoxide and hydrogen can be further contacted with a water-gas shift conversion catalyst in the presence of steam to obtain a water-gas shift effluent, and optionally selectively oxidising the then remaining carbon monoxide by contacting the water-gas shift effluent with a catalyst for the selective oxidation of carbon monoxide, to produce a hydrogen-rich gas stream. The products can be fed to the anode of a fuel cell.

### FIELD OF THE INVENTION

The present invention relates to a process for the catalytic conversion of a gasoline composition into a gas mixture comprising carbon monoxide and hydrogen.

### BACKGROUND OF THE INVENTION

Vehicles having an on-board fuel cell are being developed. They offer a great potential for low emission transport means. On-board fuel cells may for example serve as energy provider for the propulsion system or as auxiliary power unit. For fuel cells, especially for Polymer Exchange Membrane (PEM) fuel cells, hydrogen or a hydrogen-rich gas is preferred as fuel. There is, however, no existing infrastructure for producing and distributing hydrogen. Therefore, a lot of research and development efforts have been focused on the on-board catalytic conversion of current hydrocarbon fuels into hydrogen by means of reforming. Reference herein to reforming is to several hydrocarbon conversion reactions, including steam reforming, autothermal reforming and partial oxidation, wherein a gas mixture containing hydrogen and carbon oxides is formed. These reactions are described in more detail in the art, for example in Fuel Chemistry Division Reprints 2002, 47(2), 542. Reforming of hydrocarbons results in a gas mixture comprising hydrogen, carbon monoxide and carbon dioxide.

In the near future, it is expected that cars with both an internal combustion engine and a reformer will become commercially important. Examples are cars having a catalytic reforming zone to produce a hydrogen and carbon monoxide containing mixture to feed into the internal combustion engine in order to reduce emissions and increase combustion efficiency. Other examples would be whereby a fuel cell system is used to provide auxiliary electrical power on an internal combustion engine vehicle. Such a fuel cell system could comprise a reformer in conjunction with a Solid Oxide Fuel Cell (SOFC) to create electricity, or alternatively, a fuel processor in conjunction with a PEM fuel cell.

In such cars, fuel is needed for both the internal combustion engine and for the catalytic reformer. It would be advantageous if the same fuel could be used for both purposes.

Hydrocarbonaceous fuels that are suitable for conversion in catalytic reformers or fuel processors have been described in the art. In United States Statutory Invention Registration No. H1, 849 for example, it is described that Fischer-Tropsch products can be successfully applied as fuels for fuel cell systems.

In WO 01/72932 is described a catalytic partial oxidation process wherein a fuel composition having an olefins concentration of 1-50%, preferably 5-30%, is converted into hydrogen for use in fuel cells. It is described that olefins have a reaction promoting effect on the catalytic partial oxidation and that they inhibit catalyst deterioration.

In EP 1 266 949 is described a fuel oil for use both in an internal combustion engine and in catalytic reforming. The fuel oil contains at least 50% by volume of alkylate.

Disadvantages of the use of alkylate are that it is an expensive gasoline ingredient and that hydrogen fluoride, which is a dangerous compound, is used as catalyst in its production. Therefore, it is desired to minimise the amount of alkylate in a gasoline composition.

### SUMMARY OF THE INVENTION

In one embodiment, a process for the catalytic conversion of a gasoline composition into a gas mixture comprising carbon monoxide and hydrogen is provided, the process comprising contacting a mixture of the gasoline composition and an oxygen-containing gas and/or steam with a catalyst for steam reforming, autothermal reforming or partial oxidation thereby producing a gas mixture comprising carbon monoxide and hydrogen.

The gasoline composition contains at most 40% by volume of alkylate and at most 3% by volume of olefins having 6 or more carbon atoms and has a RON of at least 85.

In another embodiment, a process for producing a hydrogen-rich gas stream is provided, comprising contacting the gas mixture comprising carbon monoxide and hydrogen produced by the process described above with a water-gas shift conversion catalyst in the presence of steam to obtain a water-gas shift effluent, and optionally selectively oxidising the then remaining carbon monoxide by contacting the water-gas shift effluent with a catalyst for the selective oxidation of carbon monoxide to produce a hydrogen-rich gas stream.

In yet another embodiment, a fuel cell system is provided wherein the gas mixture comprising carbon monoxide and hydrogen produced by the process described above or the water-gas shift effluent or the hydrogen-rich gas stream produced by the process described above is fed to the anode of a fuel cell.

### DETAILED DESCRIPTION OF THE INVENTION

In the near future, it is expected that cars with both an internal combustion engine and a reformer will become commercially important. Examples are cars having a catalytic reforming zone to produce a hydrogen and carbon monoxide containing mixture to feed into the internal combustion engine in order to reduce emissions and increase combustion efficiency. Other examples would be whereby a fuel cell system is used to provide auxiliary electrical power on an internal combustion engine vehicle. Such a fuel cell system could comprise a reformer in conjunction with a Solid Oxide Fuel Cell (SOFC) to create electricity, or alternatively, a fuel processor in conjunction with a PEM fuel cell.

In such cars, fuel is needed for both the internal combustion engine and for the catalytic reformer. It would be advantageous if the same fuel could be used for both purposes.

It is an aim of the present invention to provide for a gasoline fuel that shows a good performance in both a spark ignition engine and in a catalytic reformer, whilst having no or a low amount of alkylate.

It has been found that gasoline compositions that have no or a very low amount of higher olefins, i.e. olefins having 6 or more carbon atoms, have a positive effect on the stability of reforming catalysts. It has also been found that gasoline compositions with such low amounts of higher olefins can be composed without using high amounts of alkylate, whilst still being very suitable for catalytic reformers and having a sufficiently high Research Octane Number (RON) to be suitable for spark ignition engines.

Accordingly, the present invention relates to a process for the catalytic conversion of a gasoline composition into a gas mixture comprising carbon monoxide and hydrogen, the process comprising contacting a mixture of the gasoline composition and an oxygen-containing gas and/or steam with a catalyst for steam reforming, autothermal reforming or partial oxidation, wherein the gasoline composition contains at most 40% by volume of alkylate and at most 3% by volume of olefins having 6 or more carbon atoms and has a RON of at least 85.

Gasolines typically contain mixtures of hydrocarbons boiling in the range of from 30° C. to 230° C., the optimal ranges and distillation curves varying according to climate and season of the year.

The hydrocarbons in the gasoline composition used in the process according to the invention may conveniently be derived in known manner from straight-run gasoline, naphtha from synthetically-produced aromatic hydrocarbon mixtures, thermally or catalytically cracked hydrocarbons, hydrocracked petroleum fractions, catalytically reformed hydrocarbons, isomerate, alkylate and mixtures of these. Reference in this paragraph to catalytic reforming is to the conventional catalytic reforming or platforming process such as applied in refineries to produce a high octane gasoline blending component from hydrotreated naphtha. This process is completely different from the catalytic reforming further referred to herein.

Oxygenates may be incorporated in the gasoline composition used in the process according to the invention, and these include alcohols such as methanol, ethanol, isopropanol, tertiary butyl alcohol and isobutanol, and ethers, preferably ethers containing 5 or more carbon atoms per molecule, e.g. methyl tertiary butyl ether (MTBE) or ethyl tertiary butyl ether (ETBE). The ethers containing 5 or more carbon atoms per molecule may be used in amounts up to 15% v/v, but if methanol is used, it can only be in an amount up to 3% v/v, and stabilisers will be required. Stabilisers may also be needed for ethanol, which may be used up to 5% v/v. Isopropanol may be used up to 10% v/v, tertiary butyl alcohol up to 7% v/v and isobutanol up to 10% v/v.

Preferably, the gasoline composition used in the process according to the inventions comprises oxygenates in an amount of 1 to 15% by volume. Preferred oxygenates are selected from methanol, ethanol, isopropanol, isobutanol, tertiary butyl alcohol, MTBE, ETBE or a combination of two or more thereof, a particularly preferred oxygenate is ethanol.

The gasoline composition will be composed such from hydrocarbon streams and oxygenates that it will have at most 3% by volume of olefins having 6 or more carbon atoms and a RON of at least 85. The amount of alkylate in the gasoline composition is at most 40% by volume, preferably at most 30% by volume, even more preferably at most 10% by volume for the reasons described above. Most preferably, the gasoline composition is essentially free of alkylate.

In order to be suitable for a spark ignition engine, the gasoline composition has a RON of at least 85, preferably at least 90, more preferably at least 95.

Common gasolines typically have an olefins content in the range of from 5 to 30% by volume. The gasoline composition used in the process according to the invention contains at most 3% by volume of olefins having 6 or more carbon atoms. Preferably the gasoline composition has a total olefin content of at most 3% by volume, more preferably at most 1% by volume. The content of olefins having 6 or more carbon atoms is preferably at most 1% by volume, more preferably the gasoline composition is essentially free of olefins having 6 or more carbon atoms. It will be appreciated that the amounts of thermally or catalytically cracked hydrocarbons that can be used in the gasoline composition of the process according to the invention are limited, since these streams comprise a relatively high amount of olefins.

The gasoline composition used in the process of the present invention may variously include one or more additives that are generally employed in conventional gasolines, such as anti-oxidants, corrosion inhibitors, ashless detergents, dehazers, dyes and synthetic or mineral oil carrier fluids.

Catalysts for reforming, i.e. steam reforming, autothermal reforming and partial oxidation catalysts, the other catalysts in a fuel processor, i.e. water-gas shift conversion catalysts and selective oxidation catalysts, and fuel cell catalysts are highly sensitive to sulfur. Therefore, it is preferred that the gasoline composition used in the process according to the invention has a low sulfur content. Preferably, the sulfur content is at most 50 ppm, more preferably at most 5 ppm, even more preferably at most 1 ppm. It will appreciated that if a high conversion of the gasoline is not required or if a sulfur trap is incorporated in the fuel processor, a higher sulfur concentration can be tolerated.

It is preferred that the gasoline composition used in the process according to the invention has a hydrogen to carbon ratio of at least 1.7. The advantage of a high hydrogen to carbon ratio is that the in-situ production of water in the fuel processor is relatively high. This water can advantageously be used in the fuel processor, as reactant for the water-gas shift reaction, or in the PEM fuel cell.

The final boiling point of the gasoline used in the process according to the invention is preferably at most 190° C., more preferably at most 170° C. A low final boiling point will minimise coke formation on the reformer catalyst and improve the ease of vaporisation of the gasoline composition. It will be appreciated that coke formation also depends on other parameters such as operating temperature, catalyst composition and gas velocity. It will further be appreciated that there is a practical limit to the extent to which the less volatile components can be eliminated from the gasoline in that the gasoline requirements for the Reid Vapor Pressure (RVP) must still be met. Typically, the RVP should be at most 60 kPA for summer grade gasoline.

The catalytic reaction(s) that take(s) place in the process according to the invention is/are steam reforming, autothermal reforming, partial oxidation or a combination thereof. These reactions are known in the art, for example from Fuel Chemistry Division Reprints 2002, 47(2), 542.

If the process is a steam reforming process, a mixture of the gasoline composition and steam is contacted with the catalyst. An oxygen-containing gas may be present. If the reaction is the partial oxidation and/or autothermal reforming of gasoline, then a mixture of the gasoline composition and the oxygen-containing gas are contacted with the catalyst. The use of steam is then optional. The oxygen-containing gas may be air, oxygen or oxygen-enriched air, preferably air.

For catalytic partial oxidation and autothermal reforming, the gasoline composition and the oxygen-containing gas are preferably mixed in such amounts that the oxygen-to-carbon ratio is in the range of from 0.3 to 0.8, more preferably of from 0.4 to 0.65. Reference herein to the oxygen-to-carbon ratio is to the ratio of oxygen in the form of molecules (O₂) to carbon atoms present in the gasoline composition.

If steam is present in the process according to the invention, the steam-to-carbon ratio is preferably in the range of from 0.1 to 3.0, more preferably of from 0.1 to 2.0.

The catalytic partial oxidation and autothermal reforming reactions typically take place at a temperature in the range of from 600 to 1200° C. Steam reforming may take place at a lower temperature, but typically above 400° C.

Catalysts suitable for the process according to the invention are known in the art, for example from EP 629,578, WO 99/37580, or WO 01/46069. Typically these catalysts comprise at least one Group VIII metal as catalytically active component supported on a porous arrangement of a ceramic or metal catalyst carrier. The catalyst may further comprise a promoter, typically selected from the cations of Al, My, Zr, Ti, La, Hf, Si, Ba and Ce.

The process according to the invention is advantageously applied on-board a vehicle that contains both a spark ignition engine and a catalytic reformer. The catalytic reformer may be present as such or may be part of a fuel processor and/or a fuel cell system.

Reforming of hydrocarbons results in a gas mixture comprising hydrogen, carbon monoxide and carbon dioxide. Some fuel cell catalysts are poisoned by carbon monoxide, in particular the catalyst of PEM fuel cells. A so-called fuel processor typically comprises in series a reformer, wherein a hydrocarbonaceous fuel is catalytically converted into a gas mixture comprising carbon oxides and hydrogen, a water-gas shift conversion zone, and, optionally, a catalytic zone for the selective oxidation of the remaining carbon monoxide.

If the catalytic reformer is part of a fuel processor, the carbon monoxide in the effluent of the reformer is catalytically converted to carbon dioxide by contacting it in the presence of steam with a water-gas shift conversion catalyst to obtain a water-gas shift effluent. The water-gas shift effluent is optionally contacted with a catalyst for the selective oxidation of carbon monoxide to selectively oxidise the remaining carbon monoxide to obtain a hydrogen-rich gas stream. The fuel processor may be part of a fuel cell system comprising in series the fuel processor and a fuel cell. In that case, the water-gas shift effluent or the hydrogen-rich gas stream obtained after selective oxidation is fed to the anode of a fuel cell, preferably a PEM fuel cell, to generate energy.

The catalytic reformer may be part of a fuel cell system comprising the reformer and a solid oxide fuel cell (SOFC). The effluent of the catalytic reformer, i.e. the gas mixture comprising carbon monoxide and hydrogen, is then directly fed to the anode of the SOFC to generate energy.

### EXAMPLES

The process according to the invention will be illustrated by means of the following illustrative embodiments that are provided for illustration only and are not to be construed as limiting the claimed invention in any way.

### Example 1

A 3.6 mm inner diameter quartz tube was loaded over a length of 15 cm with catalyst particles (40-60 mesh) comprising 0.7 wt % Rh and 0.7 wt % Ir on Y-PSZ (zirconia partially-stabilised with yttria) and placed in an oven. A preheated mixture (90° C.) of reactant and steam with a steam-to-carbon ratio of 1.0 was led over the catalyst at such space velocity that the contact time was 100 msec. The oven temperature was incrementally increased from 300 to 900°° C. At each temperature, the composition of the catalyst effluent was measured by means of mass spectrometry. In table 1, the temperature at which 50% of the reactant was converted is shown for eight different reactants. It is clear from table 1 that the C₆⁺ olefins, i.e. diisobutylene, 1-octene, and 1-hexene, have a lower steam reforming activity than the other reactants. Diisobutylene is a also known as 2,4,4-trimethyl-pentene; it is a mixture of the isomers 2,4,4-trimethyl-1-pentene and 2,4,4-trimethyl-2-pentene.

TABLE 1
Steam reforming activity of different reactants

| reactant | temperature at 50% conversion (° C.) |
|---|---|
| diisobutylene | 645 |
| 1-octene | 620 |
| 1-hexene | 630 |
| n-heptane | 520 |
| cyclo-hexane | 525 |
| iso-octane | 515 |
| 1-pentene | 510 |
| 1-butene | 520 |
| ethanol | 410 |

### Example 2

Catalyst Preparation

A catalyst carrier in the form of a knitted arrangement of commercially available fecralloy wire (wire diameter 0.2 mm; ex. Resistalloy, UK; wire composition: 72.6% wt Fe, 22% wt Cr, 5.3% wt Al, and 0.1% wt Y), pressed in the shape of a cylinder (diameter: 13 mm; height: 15 mm) was calcined at a temperature of 1050° C. during 48 hours. The calcined wire arrangement had a weight of 3 grams and was once dipcoated in a commercially available partially-stabilised zirconia (zirconium oxide, type ZO, ex. ZYP Coatings Inc., Oak Ridge, USA). The zirconia is partially stabilised with 4% wt CaO. After dipcoating, the arrangement was calcined for 2 hours at 700° C. The coated arrangement was further provided with 1.0 wt % Rh, 1.0 wt % Ir, zirconia (0.7 wt % Zr) and ceria (2.0 wt % Ce), based on the total weight of the catalyst, by immersing it three times in an aqueous solution comprising rhodium trichloride, iridium tetra chloride, zirconyl nitrate and Ce(NO₃)₃.6H₂O. After each immersion, the arrangement was dried at 140° C. and calcined for 2 hours at 700° C.

Catalytic Partial Oxidation

In a 14 mm inner diameter quartz tube, the above-described partial oxidation catalyst was loaded. A pre-heated (300° C.) mixture of reactant, air and steam was led over the catalyst in such amounts that the oxygen-to-carbon ratio was 0.5, the steam-to-carbon ratio 1.0 and the gas velocity 500,000 Nl feed mixture/kg catalyst/h. The operating pressure was 3 bar (absolute). The temperature of the catalyst effluent was 800° C.

The yield (moles hydrogen and carbon monoxide per mole of reactant) was determined as a function of the runtime. The deactivation rate was calculated (decrease in yield per hour). A negative deactivation rate means that the yield decreases with runtime. Table 2 gives the deactivation rate for different hydrocarbons as reactant. It is clear from table 2 that the use of higher olefins such as 1-octene or diisobutylene as reactant results in a much higher deactivation rate than the use of non-olefinic hydrocarbons.

TABLE 2
Catalytic partial oxidation

| reactant | deactivation rate (h⁻¹) |
|---|---|
| iso-octane | −0.001 |
| n-heptane | −0.001 |
| cyclo-hexane | −0.001 |
| toluene | −0.002 |
| MTBE | −0.001 |
| 1-octene | −0.06 |
| diisobutylene | −0.06 |

### Examples 3-5

A preheated mixture of a gasoline composition, air and steam was led over a partial oxidation catalyst comprising Rh, Ir and zirconium oxide on a Fe—Cr—Al alloy wire arrangement. In table 3 is given the composition of the gasoline, the catalyst composition, the oxygen-to-carbon ratio, steam-to-carbon ratio, preheat temperature, and gas velocity of the feed mixture and the operating pressure.

The yield (moles hydrogen and carbon monoxide per mole of reactant) was determined as a function of the runtime. The deactivation rate was calculated (decrease in yield per hour) and is given in table 3. It is clear from table 3 that the deactivation rate in example 5 (more than 3 volume % C₆⁺ olefins present) is much higher than in the examples according to the invention (examples 3 and 4).

TABLE 3
Gasoline experiments

| | Example 3 | Example 4 | Example 5 |
|---|---|---|---|
| | (invention) | (invention) | (comp.) |
| paraffins | 61.4 | 48.71 | 73.6 |
| (vol %) | | | |
| olefins (vol %) | 2.32 | 0.7 | 4.43 |
| aromatics | 27.2 | 35.5 | 14.4 |
| (vol %) | | | |
| naphthenes | 2.6 | ?1 | 7.7 |
| (vol %) | | | |
| MTBE (vol %) | 4.6 | 15.1 | — |
| Sulfur (ppm) | <1 | <1 | <1 |
| catalyst | 0.9 wt % Rh, | 0.9 wt % Rh, | 0.7 wt % Rh, |
| composition | 0.9 wt % Ir, | 0.9 wt % Ir, | 0.7 wt % Ir, |
| | 0.6 wt % Zr | 0.6 wt % Zr | 0.7 wt % Zr |
| oxygen: carbon | 0.47 | 0.47 | 0.46 |
| steam: carbon | 1.0 | 0.93 | 1.0 |
| preheat T (° C.) | 240 | 320 | 284 |
| gas velocity | 500,000 | 550,000 | 750,000 |
| (Nl/kg | | | |
| catlyst/h) | | | |
| pressure (bara) | 3.0 | 3.0 | 4.3 |
| deactivation | −0.005 | −0.01 | −0.15 |
| rate (h⁻¹) | | | |
| RON | >95 | 99.1 | |

¹paraffins and naphthenes
²all olefins are isobutene
³all olefins are diisobutylene

We claim:

1. A process for the catalytic conversion of a gasoline composition into a gas mixture comprising carbon monoxide and hydrogen, the process comprising contacting a mixture of the gasoline composition and an oxygen-containing gas and/or steam with a catalyst for steam reforming, autothermal reforming or partial oxidation thereby producing a gas mixture comprising carbon monoxide and hydrogen, wherein the gasoline composition contains at most 40% by volume of alkylate and at most 3% by volume of olefins having 6 or more carbon atoms and has a RON of at least 85.

2. The process of claim 1 wherein the gasoline composition has a total olefins content of at most 3% by volume.

3. The process of claim 2 wherein the gasoline composition has a total olefins content of at most 1% by volume.

4. The process of claim 1 wherein the gasoline composition contains at most 1% by volume of olefins having 6 or more carbon atoms.

5. The process of claim 4 wherein the gasoline composition is essentially free of olefins having 6 or more carbon atoms.

6. The process of claim 1 wherein the gasoline composition contains at most 30% by volume of alkylate.

7. The process of claim 6 wherein the gasoline composition contains at most 10% by volume of alkylate.

8. The process of claim 6 wherein the gasoline composition is essentially free of alkylate.

9. The process of claim 1 wherein the gasoline composition has a RON of at least 90.

10. The process of claim 9 wherein the gasoline composition has a RON of at least 95.

11. The process of claim 1 wherein the gasoline composition has sulfur content of at most 50 ppm.

12. The process of claim 1 wherein the gasoline composition has sulfur content of at most 5 ppm.

13. The process of claim 1 wherein the gasoline composition has sulfur content of at most 1 ppm.

14. The process of claim 2 wherein the gasoline composition has sulfur content of at most 50 ppm.

15. The process of claim 4 wherein the gasoline composition has sulfur content of at most 50 ppm.

16. The process of claim 1 wherein the gasoline composition has a hydrogen to carbon ratio of at least 1.7.

17. The process of claim 1 wherein the gasoline composition has a final boiling point of at most 190° C.

18. The process of claim 1 wherein the gasoline composition has a final boiling point of at most 170° C.

19. The process of claim 1 wherein the gasoline composition comprises 1 to 15% by volume of oxygenate.

20. The process of claim 19 wherein the gasoline composition comprises an oxygenate selected from the group consisting of methanol, ethanol, isopropanol, isobutanol, tertiary butyl alcohol, MTBE, ETBE and combinations thereof.

21. The process of 1 wherein the gasoline composition comprises up to 5% by volume ethanol.

22. The process of claim 1 further comprising contacting the gas mixture comprising carbon monoxide and hydrogen with a water-gas shift conversion catalyst in the presence of steam to obtain a water-gas shift effluent, and optionally selectively oxidising the then remaining carbon monoxide by contacting the water-gas shift effluent with a catalyst for the selective oxidation of carbon monoxide, thereby produce a hydrogen-rich gas stream.

23. A fuel cell system wherein the gas mixture comprising carbon monoxide and hydrogen produced by the process of claim 1 is fed to the anode of a fuel cell.

24. A fuel cell system wherein the gas mixture comprising carbon monoxide and hydrogen produced by the process of claim 2 is fed to the anode of a fuel cell.

25. A fuel cell system wherein the gas mixture comprising carbon monoxide and hydrogen produced by the process of claim 4 is fed to the anode of a fuel cell.

26. A fuel cell system wherein the gas mixture comprising carbon monoxide and hydrogen produced by the process of claim 7 is fed to the anode of a fuel cell.

27. A fuel cell system wherein the gas mixture comprising carbon monoxide and hydrogen produced by the process of claim 9 is fed to the anode of a fuel cell.

28. A fuel cell system wherein the gas mixture comprising carbon monoxide and hydrogen produced by the process of claim 11 is fed to the anode of a fuel cell.

29. A fuel cell system wherein the gas mixture comprising carbon monoxide and hydrogen produced by the process of claim 12 is fed to the anode of a fuel cell.

30. A fuel cell system wherein the gas mixture comprising carbon monoxide and hydrogen produced by the process of claim 17 is fed to the anode of a fuel cell.

31. A fuel cell system wherein the gas mixture comprising carbon monoxide and hydrogen produced by the process of claim 19 is fed to the anode of a fuel cell.

32. A fuel cell system wherein the water-gas shift effluent produced by the process of claim 22 is fed to the anode of a fuel cell.

33. A fuel cell system wherein the hydrogen-rich gas stream produced by the process of claim 22 is fed to the anode of a fuel cell.

34. The process of claim 2 further comprising contacting the gas mixture comprising carbon monoxide and hydrogen with a water-gas shift conversion catalyst in the presence of steam to obtain a water-gas shift effluent, and optionally selectively oxidising the then remaining carbon monoxide by contacting the water-gas shift effluent with a catalyst for the selective oxidation of carbon monoxide, thereby produce a hydrogen-rich gas stream.

35. A fuel cell system wherein the water-gas shift effluent produced by the process of claim 34 is fed to the anode of a fuel cell.

36. A fuel cell system wherein the hydrogen-rich gas stream produced by the process of claim 34 is fed to the anode of a fuel cell.

37. The process of claim 4 further comprising contacting the gas mixture comprising carbon monoxide and hydrogen with a water-gas shift conversion catalyst in the presence of steam to obtain a water-gas shift effluent, and optionally selectively oxidising the then remaining carbon monoxide by contacting the water-gas shift effluent with a catalyst for the selective oxidation of carbon monoxide, thereby produce a hydrogen-rich gas stream.

38. A fuel cell system wherein the water-gas shift effluent produced by the process of claim 37 is fed to the anode of a fuel cell.

39. A fuel cell system wherein the hydrogen-rich gas stream produced by the process of claim 37 is fed to the anode of a fuel cell.
